(19) United States
(12) Patent Application Publication
(10) Pub. No.: US 2016/0063163 A1
(43) Pub. Date: Mar. 3, 2016

(54) ARRAYS WITH COMPACT SERIES CONNECTION FOR VERTICAL NANOWIRES REALIZATIONS

(71) Applicant: SYNOPSYS, INC., Mountain View, CA (US)

(72) Inventors: Victor Moroz, Saratoga, CA (US); Jamil Kawa, Campbell, CA (US)

(73) Assignee: SYNOPSYS, INC., MOUNTAIN VIEW, CA (US)

(21) Appl. No.: 14/834,780

(22) Filed: Aug. 25, 2015

Related U.S. Application Data
(60) Provisional application No. 62/041,854, filed on Aug. 26, 2014.
(60) Provisional application No. 62/054,227, filed on Sep. 23, 2014.
(60) Provisional application No. 62/054,653, filed on Sep. 24, 2014.

(51) Int. Cl. G06F 17/50; H01L 27/02

(52) U.S. Cl. CPC G06F 17/5068; H01L 27/0207

(57) ABSTRACT

An integrated circuit design tool includes a functional cell library. An entry in the cell library comprises a specification of the cell. Entries in the cell library including specifications of particular cells in a computer executable language. At least one entry in the cell library comprising a specification of a cell including a plurality of transistors and an interconnect. At least two transistors in the plurality are in series via at least the interconnect. The transistors and the interconnect can be vertically oriented to support vertical current through a vertical channel relative to the substrate.

### PRIORITY APPLICATION

This application claims the benefit of U.S. Provisional Patent Application No. 62/041,854 filed 26 Aug. 2014; U.S. Provisional Patent Application No. 62/054,227 filed 23 Sep. 2014; and U.S. Provisional Patent Application No. 62/054,653 filed 24 Sep. 2014. All applications are incorporated herein by reference.

### BACKGROUND

1. Field of the Invention

The present invention relates to integrated circuit devices, cell libraries, cell architectures and electronic design automation tools for integrated circuit devices.

2. Description of Related Art

In the design of integrated circuits, standard functional cell libraries are often utilized. The process of designing the functional cells specified by entries in the cell libraries can be an intensive, where trade-offs among variables such as the size of the cells, the drive power of the cells, the speed of the cells and so on, are made by adjusting the materials, geometry and size of the components of the cell. The procedure of designing cells to be specified in a cell library is often a labor-intensive process, requiring highly skilled designers to manually design and refine the designs of the functional cells.

The development of finFETs has provided some additional flexibility for designers which can be applied in the efficient design of variations of specific functional cells. Thus, some functional libraries are based on FinFETs. FinFETs have been implemented in block structures having a grid structure, in which fins are laid out in parallel in first direction on a substrate with a narrow pitch, and gates are laid out in an orthogonal direction across the fins. The individual functional cells are formed using sets of complementary n-channel and p-channel transistors having their source, drain and channel in the fins. The drive power and other characteristics of individual transistors in a functional cell utilizing FinFETs can be adjusted by increasing or decreasing the number of identical fins utilized in parallel as the channel structure for a given transistor. This provides some granularity of design in the development of a cell library. However, many circuit parameters can benefit from finer tuning of circuit structures. To fine-tune finFET type circuits, complex reconfiguration of the fins or other structures may be required.

It is desirable to provide a functional cell design architecture suitable for implementation of functional cells for a functional cell library that can provide for fine variations in circuit parameters while reducing the design time and design effort required.

### SUMMARY

A cell architecture, and an integrated circuit design tool utilizing the cell architecture, are described. The functional cell library can have entries for plurality of functional cells. Entries include specifications of particular cells in a computer readable description language applying a cell architecture that includes transistors and interconnects implemented utilizing nanowires. Thus, at least one entry in the cell library can comprise a specification of the cell including a first transistor and a second transistor. The first transistor can include a first set of nanowires arranged in parallel to form a channel structure, and a gate conductor disposed across the first set of nanowires. The second transistor can include a second set of nanowires arranged in parallel to form a channel structure, and a gate conductor disposed across the first set of nanowires. The number of nanowires in the first set can be different from the number of nanowires in the second set, so that the drive power of the individual transistors can be set with fine granularity.

A cell library is described taking advantage of this granularity, which can include a set of functional cells that implement a common circuit, such as a NAND gate or other common logic cell. The cells in the set of functional cells can differ in the number of parallel nanowires used in the implementation of a particular transistor in the common circuit. Also, the cells in the set of functional cells can differ in the number of parallel nanowires used in the implementation of a particular interconnect in the common circuit. These variations in the number of parallel nanowires can provide for fine gradations in drive power or other characteristics of the transistors, and correspondingly different performance characteristics for the functional cell.

Nanowires can be used as interconnect elements in the construction of a cell library elements. Also, a horizontal N+ island used for the purpose of interconnect between vertical nanowire devices is described in this disclosure.

An integrated circuit is described which can be manufactured using a cell library like that described herein.

One aspect of the technology is a computer system adapted to process a computer implemented representation of a circuit design, comprising a processor and a memory coupled to the processor. The memory stores processor readable parameters specifying structural features of a physical implementation of a circuit. The circuit includes a plurality of nanowire transistors, and a nanowire interconnect. At least two nanowire transistors in the plurality are electrically in series via at least the nanowire interconnect.

In some embodiments, said at least two transistors are oriented vertically relative to a substrate. Some embodiments further comprise a conductor electrically connecting a source terminal of a first transistor of said at least two transistors and a drain terminal of a second transistor of said at least two transistors.

In some embodiments, said first transistor and said second transistor are a same conductivity type.

In some embodiments, the nanowire interconnect has an opposite conductivity type in contrast with said first vertical nanowire transistor and said second vertical nanowire transistor.

In some embodiments, said at least two nanowire transistors include a first vertical nanowire transistor and a second vertical nanowire transistor both being n-type transistors, and said nanowire interconnect is a first vertical nanowire electrically connecting a first drain of the first vertical nanowire transistor with a first source of the second vertical nanowire transistor.

Another aspect of the technology is a computer program product as described herein.

A further aspect of the technology is a computer program product, comprising a memory device having stored thereon a machine readable specification of a cell, the specification of the cell including computer readable parameters specifying structural features of a physical implementation of a circuit. The circuit includes an array of circuit cells, the circuit cells including a plurality of nanowire transistors and a vertical nanowire interconnect. The plurality of nanowire transistors includes a first vertical nanowire transistor and a second vertical nanowire transistor. The first vertical nanowire transistor includes a first gate at a first intermediate height in between a first source at a first source height and a first drain at a first drain height. The second vertical nanowire transistor includes a second gate at a second intermediate height in between a second source at a second source height and a second drain at a second drain height. The vertical nanowire interconnect traverses the first intermediate height of the first vertical nanowire transistor, and traverses the second intermediate height of the second vertical nanowire transistor, to electrically couple in series the first vertical nanowire transistor and the second vertical nanowire transistor.

In some embodiments said first vertical nanowire transistor and said second vertical nanowire transistor are a same conductivity type. In some embodiments the vertical nanowire interconnect has an opposite conductivity type in contrast with said first vertical nanowire transistor and said second vertical nanowire transistor.

In some embodiments said first vertical nanowire transistor and said second vertical nanowire transistor are n-type transistors, and said first vertical nanowire electrically connects the first drain of the first vertical nanowire transistor with the first source of the second vertical nanowire transistor.

In some embodiments said first vertical nanowire transistor and said second vertical nanowire transistor are a same conductivity type, and the circuit further comprises a third vertical nanowire transistor a third vertical nanowire transistor and a fourth vertical nanowire transistor, and a first conductor and a second conductor.

The third vertical nanowire transistor and the fourth vertical nanowire transistor have an opposite conductivity type in contrast with said first vertical nanowire transistor and said second vertical nanowire transistor.

The first conductor electrically connects the first gate of the first vertical nanowire transistor with a third gate of the third vertical nanowire transistor. The second conductor electrically connects the second gate of the second vertical nanowire transistor with a fourth gate of the fourth vertical nanowire transistor.

The first conductor and the second conductor are different electrical inputs of a NAND gate.

Yet a further aspect of the technology is a computer system adapted to process a computer implemented representation of a circuit design, as described herein. Other aspects and advantages of the present technology can be seen on review of the figures, the detailed description, and the claims which follow.

### BRIEF DESCRIPTION OF THE DRAWINGS

FIGS. 1A and 1B illustrate a schematic symbol and a transistor level schematic for a two-input NAND gate.

FIG. 2 is a simplified layout diagram showing a top view of a two-input NAND gate implemented with nanowire devices and nanowire interconnects using vertical nanowires.

FIG. 2A is a legend applicable to FIGS. 2 through 5.

FIG. 3 is a layout diagram showing a cross-sectional view of the two-input NAND gate in FIG. 2 taken at X-X′.

FIG. 4 is a layout diagram showing a cross-sectional view of the two-input NAND gate in FIG. 2 taken at Y-Y′.

FIG. 5 is a layout diagram showing a cross-sectional view of the two-input NAND gate in FIG. 2 taken at Z-Z′.

FIG. 6 is a simplified layout diagram showing a top view of a two-input NAND gate implemented with horizontal and vertical nanowires.

FIG. 6A is a legend applicable to FIGS. 6 through 9.

FIG. 7 is a layout diagram showing a cross-sectional view of the two-input NAND gate in FIG. 6 taken at X-X′.

FIG. 8 is a layout diagram showing a cross-sectional view of the two-input NAND gate in FIG. 6 taken at Y-Y′.

FIG. 9 is a layout diagram showing a cross-sectional view of the two-input NAND gate in FIG. 6 taken at Z-Z′.

FIG. 10 is a simplified layout diagram showing a top view of a two-input NAND gate implemented with vertical nanowires, vertical nanowire interconnects and horizontal n+ island interconnect.

FIG. 10A is a legend applicable to FIGS. 10 through 15.

FIG. 11 is a layout diagram showing a cross-sectional view of the two-input NAND gate in FIG. 10 taken at Z-Z′.

FIG. 12 is a layout diagram showing a top view of a two-input NAND gate of FIG. 10 with top view of M0 and M1 interconnect

FIG. 13 is a layout diagram showing a cross-sectional view of the two-input NAND gate N-devices in FIG. 12 with n+ island interconnect taken at X-X′.

FIG. 14 is a layout diagram showing a cross-sectional view of the two-input NAND gate in FIG. 12 with n+p+ interconnect islands taken at Y-Y′

FIG. 15 is a layout diagram showing a cross-sectional view of the two-input NAND gate in FIG. 10 with M0 and M1 interconnect taken at Z-Z′

FIG. 16 shows a simplified representation of an illustrative integrated circuit design flow.

FIGS. 17A, 17B and 17C are simplified block diagrams of a computer system suitable for use with embodiments of the technology, as well as circuit design and circuit embodiments of the technology.

FIG. 18 is a simplified flow diagram of a process for designing a nanowire cell for a cell library.

FIG. 19 is a flowchart for a representative design automation process which can be implemented as logic executed by a system like that represented by FIGS. 17A, 17B and 17C.

### DETAILED DESCRIPTION

A detailed description of embodiments of the present invention is provided with reference to the Figures. The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

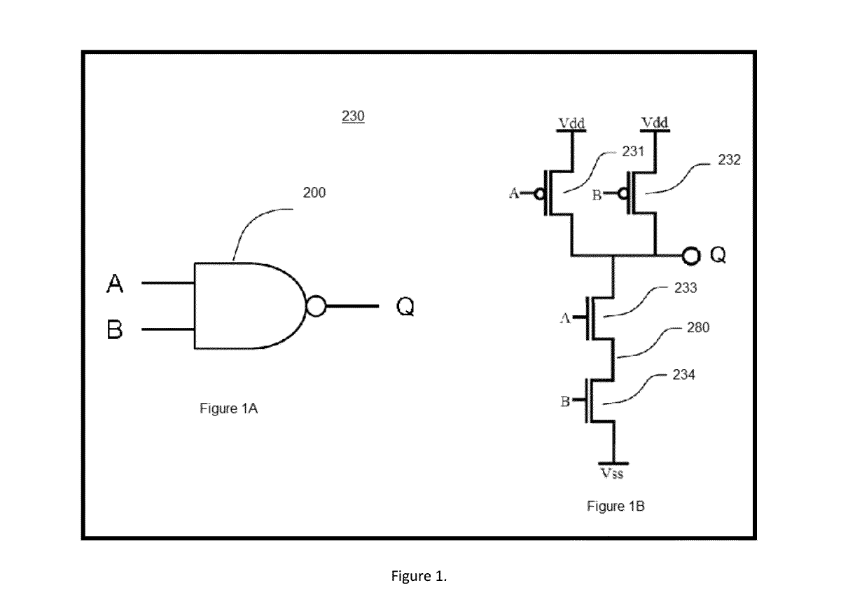

FIGS. 1A and 1B illustrate a schematic symbol and a transistor level schematic for a two-input NAND gate which can be implemented using vertical nanowire structures as described herein.

FIG. 1A shows an NAND gate 200 with two inputs A and B and an output Q. The logic function of an NAND gate is that when both inputs are at logic high, the output is at logic low, and when at least one of the inputs is at logic low, the output is at logic high.

FIG. 1B shows a transistor level schematic for a two-input NAND gate 230 with two inputs A and B and an output Q. A functional cell implementing a NAND gate can have the particular circuit configuration shown. A cell library can include more than one cell that implements the same particular circuit configuration, differing in the number of nanowires used in implementation of a particular transistor or interconnect in the circuit, or of particular transistors or interconnects in the circuit.

The NAND gate includes two PMOS transistors 231 and 232 connected in parallel, and two NMOS transistors 233 and 234 connected in series. A transistor includes three terminals: a drain, a source and a gate. Input A is connected to gates of the PMOS transistor 231 and the NMOS transistor 233. Input B is connected to gates of the PMOS transistor 232 and the NMOS transistor 234. When a transistor is turned on by a voltage on the gate, a current flows between the drain and the source, reducing the voltage difference between the drain and source. Sources of the PMOS transistors 231 and 232 are connected to the supply voltage (e.g. Vdd), while drains of the PMOS transistors 231 and 232 are connected to the output Q. Drain of the NMOS transistor 233 is connected to the output Q, while source of the NMOS transistor 234 is connected to the ground voltage (e.g. Vss).

If a low voltage corresponding to logic low is applied to either of the inputs A or B, then at least one of the NMOS transistors 233 and 234 is turned off so that the ground voltage (e.g. Vss) is disconnected from the output Q, while at least one of the PMOS transistors 231 and 232 is turned on so that the supply voltage (e.g. Vdd) is connected to the output Q. Consequently the output Q is at logic high in response to a low voltage applied to at least one of the inputs A and B.

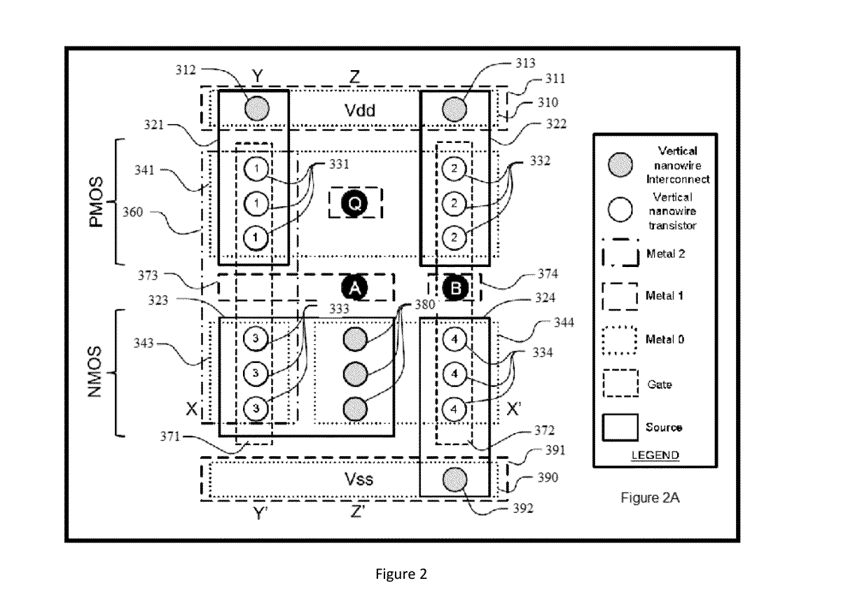

FIG. 2 is a simplified layout diagram showing a top view of a two-input NAND gate implemented with nanowires and nanowire interconnects using vertical nanowires. FIG. 2A is a legend applicable to FIGS. 2 through 5.

The two-input NAND gate is an example of a cell implemented with nanowires and nanowire interconnects that can be specified by a computer readable circuit description language, and used an entry in a cell library. The entry can be part of cell library used in electronic design synthesis. For instance, the other entries in the cell library can specify functional cells and macrocells, including buffers, inverters, AND, NAND, OR, NOR, XOR, XNOR, adders, subtractors, multiplexers, decoders, flipflops, counters, shift registers, and cells with more complex logical functions. The entries can specify a plurality of functional cells have a common circuit configuration, and are implemented with nanowires and nanowire interconnects can have a variety of drive strengths, and inverting and non-inverting outputs of same logical functions.

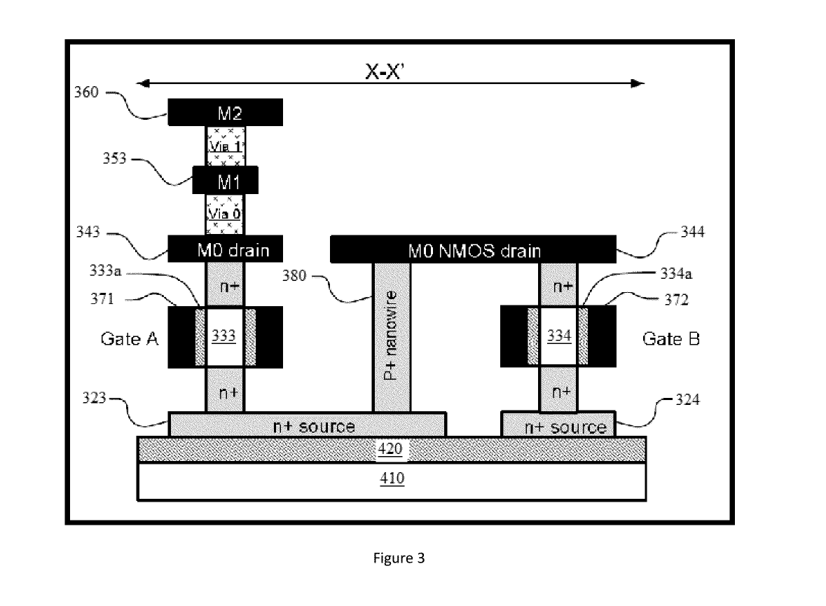

The two-input NAND gate can be disposed on a substrate (e.g. 410, FIG. 3) having a surface. As illustrated in the example of FIG. 2, a transistor 331 including a first set of nanowires disposed vertically relative to the surface of the substrate can implement the PMOS transistor 231 in the two-input NAND gate 230 (FIG. 1B), and a transistor 332 including a second set of nanowires disposed vertically relative to the surface of the substrate can implement the PMOS transistor 232 in the two-input NAND gate 130. Likewise, a transistor 233 including a third set of nanowires disposed vertically relative to the surface of the substrate can implement the NMOS transistor 233 in the two-input NAND gate 230, and a transistor 334 including a fourth set of nanowires disposed vertically relative to the surface of the substrate can implement the NMOS transistor 234 in the two-input NAND gate 230.

Components in the layout of the two-input NAND gate include patterned conductor layers that include a first metal layer (metal-0 or M0), a second metal layer (metal-1 or M1), and a third metal layer (metal-2 or M2). The metal-0 layer is beneath the metal-1 layer, and the metal-1 layer is beneath the metal-2 layer. Nanowires are beneath the metal-0 layer, and source regions for the transistors are beneath the nanowires. The first gate conductor 371 and the second gate conductor 372 cross the sets of nanowires between the first metal layer and the source regions for the nanowires. Although three patterned conductor layers are shown, more than three patterned conductor layers can be utilized.

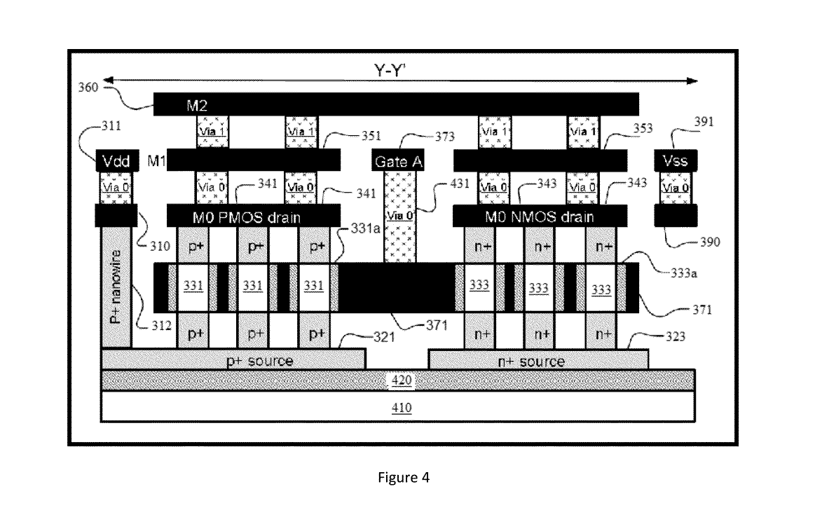

Nanowires in a set of nanowires used as a channel structure in a transistor are connected in parallel between two terminals. In particular, nanowires in transistor 331 are connected in parallel between terminals connected to the source region 321 and a metal-0 PMOS drain conductor 341 in the metal-0 layer, and nanowires in transistor 332 are connected in parallel between terminals connected to the source region 322 and the metal-0 PMOS drain conductor 341. A metal-1 conductor (e.g. 351, FIG. 4) connects the metal-0 PMOS drain conductor 341 to a metal-2 connector 360.

Nanowires in transistor 333 are connected in parallel between terminals connected to the source region 323 and a metal-0 NMOS drain conductor 343 in the metal-0 layer, and nanowires in transistor 334 are connected in parallel between terminals connected to the source region 324 and a metal-0 drain conductor 344. A metal-1 conductor (e.g. 353, FIGS. 3 and 4) connects the metal-0 PMOS drain conductor 343 to the metal-2 connector 360. Parallel connection of the nanowires is further described in connection with FIG. 4.

A first gate conductor 371 crosses the nanowires in the first set of nanowires in the transistor 331, and crosses the nanowires in the third set of nanowires in the transistor 333, between their respective two terminals. The first gate conductor 371 is connected to a metal-1 connector 373, at which a signal is applied for the input A. The metal-1 connector 373 can be connected to the first gate conductor 371 at a location on the first gate conductor 371 between the first set of nanowires in the transistor 331 and the third set of nanowires in the transistor 333.

A second gate conductor 372 crosses the nanowires in the second set of nanowires in the transistor 332, and crosses the nanowires in the fourth set of nanowires in the transistor 334, between their respective two terminals. The second gate conductor 372 is connected to a metal-1 connector 374, at which a signal is applied for the input B. The metal-1 connector 374 can be connected to the second gate conductor 372 at a location on the second gate conductor 372 between the second set of nanowires in the transistor 332 and the fourth set of nanowires in the transistor 334. The first gate conductor 371 and the second gate conductor 372 are further described in connection with FIG. 4.

A metal-0 conductor 310 in the metal-0 layer is connected to a VDD power conductor 311 in the metal-1 layer, connected to the source region 321 of the PMOS transistor 331 via nanowire interconnect 312, and connected to the source region 322 of the PMOS transistor 332 via nanowire interconnects 313. A metal-0 conductor 390 in the metal-0 layer is connected to a VSS power conductor 391 in the metal-1 layer, and connected to the source region 324 of the NMOS transistor 334 via nanowire interconnect 392.

Although three vertical nanowires are shown for each set, the first, second, third and fourth sets of nanowires can each have a number of nanowires the same as or different than other sets, depending on the need to balance NMOS and PMOS transistors or transistor strengths required by design specification. Although nanowires in a set are shown in a row of three nanowires, a set of nanowires can include multiple rows of nanowires, and each row can have a different number of nanowires. In other embodiments, nanowires of varying widths can be utilized in the various sets of nanowires.

As illustrated in the example of FIG. 2, a set of nanowires configured as a nanowire interconnect 380 is disposed vertically relative to the surface of the substrate. The set of nanowires is connected in parallel between first and second terminals. The first terminal can be one of the source region 323 of the transistor 333 and the metal-0 drain conductor 344 of the transistor 334, while the second terminal can be another of the source region 323 and the metal-0 drain conductor 344.

The nanowire interconnect 380 is further described in connection with FIG. 3. The nanowire interconnect 380 can implement the connection 280 between the NMOS transistors 233 and 234 in the circuit configuration of a two-input NAND gate 230 as illustrated in FIG. 1B.

Although one set of nanowires configured as a vertical nanowire interconnect is shown in the example of FIG. 2, more sets of nanowires can be configured as vertical nanowire interconnects. For instance, a first set of nanowires configured as a first nanowire interconnect can be disposed vertically relative to the surface of the substrate and connected in parallel between first and second terminals, and a second set of nanowires configured as a second interconnect can be disposed vertically relative to the surface of the substrate and connected in parallel between a third terminal and a fourth terminal. The first set of nanowires can include a first number of nanowires, and the second set of nanowires can include a second number of nanowires, and the second number can be different than the first number.

FIG. 3 is a diagram showing a cross-sectional view of the two-input NAND gate in FIG. 2 taken at X-X′. Elements in the two-input NAND gate are shown disposed on an insulation layer (e.g. 420) on a substrate (e.g. 410). Areas between the elements are filled with dielectric material such as silicon oxide, silicon nitride, low-k dielectric ((having a relative permeability less than that of silicon dioxide, or less than 3.9, e.g. SiOC), or with combinations of materials.

Nanowires in transistor 333 are connected in parallel between terminals connected to the source region 323 and the metal-0 NMOS drain conductor 343 in the metal-0 layer. A metal-1 conductor (e.g. 353) connects the metal-0 PMOS drain conductor 343 to the metal-2 connector 360 through Via 1 and Via 0. Nanowires in transistor 334 are connected in parallel between terminals connected to the source region 324 and the metal-0 drain conductor 344.

Nanowires in transistor 333 are sheathed by insulating material (e.g. 333a), such as silicon dioxide or a high-k insulating material (having a relative permeability greater than that of silicon dioxide, or greater than 3.9). The first gate conductor 371 crosses the nanowires in transistor 333 between the source region 323 and the metal-0 NMOS drain conductor 343. Nanowires in transistor 334 are sheathed by insulating material (e.g. 334a), such as high-k insulating material. The second gate conductor 372 crosses the nanowires in transistor 334 between the source region 324 and the metal-0 NMOS drain conductor 344.

FIG. 4 is a layout diagram showing a cross-sectional view of the two-input NAND gate in FIG. 2 taken at Y-Y′. Elements in the two-input NAND gate are shown disposed on an insulation layer (e.g. 420) on a substrate (e.g. 410). Areas between the elements are filled with dielectric material such as oxide (SiO2), nitride (SiN), or low-k dielectric (SiOC).

Nanowires in transistor 331 are connected in parallel between terminals connected to the source region 321 and the metal-0 NMOS drain conductor 341 in the metal-0 layer. A metal-1 conductor (e.g. 351) connects the metal-0 PMOS drain conductor 341 to the metal-2 connector 360 through Via 1 and Via 0. Nanowires in transistor 331 are sheathed by insulating material (e.g. 331a), such as high-k insulating material. The first gate conductor 371 crosses the nanowires in transistor 331 between the source region 321 and the metal-0 NMOS drain conductor 341.

Nanowires in transistor 333 are connected in parallel between terminals connected to the source region 323 and the metal-0 NMOS drain conductor 343 in the metal-0 layer. A metal-1 conductor (e.g. 353) connects the metal-0 PMOS drain conductor 343 to the metal-2 connector 360 through Via 1 and Via 0. Nanowires in transistor 333 are sheathed by insulating material (e.g. 333a), such as high-k insulating material. The first gate conductor 371 crosses the nanowires in transistor 333 between the source region 323 and the metal-0 NMOS drain conductor 343.

The first gate conductor 371 is connected to a metal-1 connector 373, at which a signal is applied for the input A. The first gate conductor 371 is connected to the metal-1 connector 373 through a via 431.

The metal-0 conductor 310 in the metal-0 layer is connected to the VDD power conductor 311 in the metal-1 layer, and connected to the source region 321 of the PMOS transistor 331 via nanowire interconnect 312. The metal-0 conductor 390 in the metal-0 layer is connected to the VSS power conductor 391 in the metal-1 layer, and connected to the source region 324 of the NMOS transistor 334 via nanowire interconnect 392 (not shown).

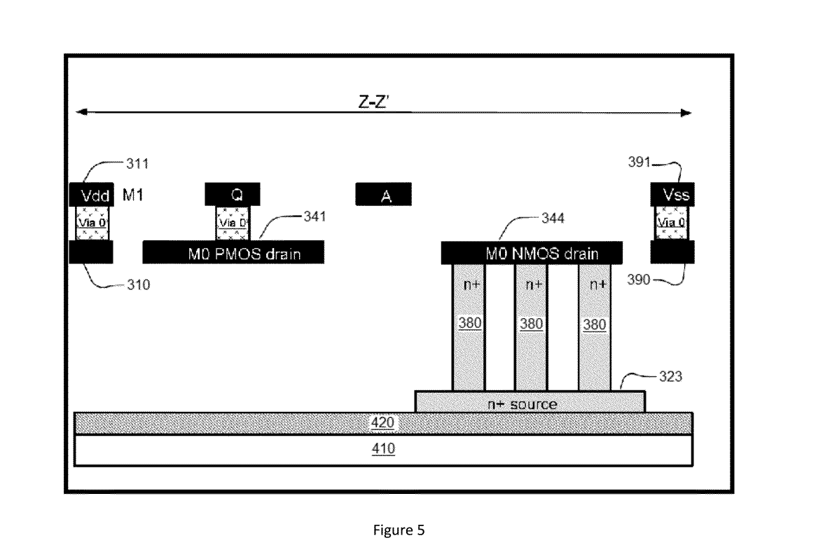

FIG. 5 is a layout diagram showing a cross-sectional view of the two-input NAND gate in FIG. 2 taken at Z-Z′. Elements in the two-input NAND gate are shown disposed on an insulation layer (e.g. 420) on a substrate (e.g. 410). Areas between the elements are filled with dielectric material such as oxide (SiO2), nitride (SiN), or low-k dielectric (SiOC).

The VDD power conductor 311 in the metal-1 layer, and the VSS power conductor 391 in the metal-1 layer are as described in connection to FIG. 4.

A set of nanowires configured as the nanowire interconnect 380 is disposed vertically relative to the surface of the substrate. The set of nanowires is connected in parallel between the source region 323 of the transistor 333 and the metal-0 NMOS drain conductor 344 of the transistor 334.

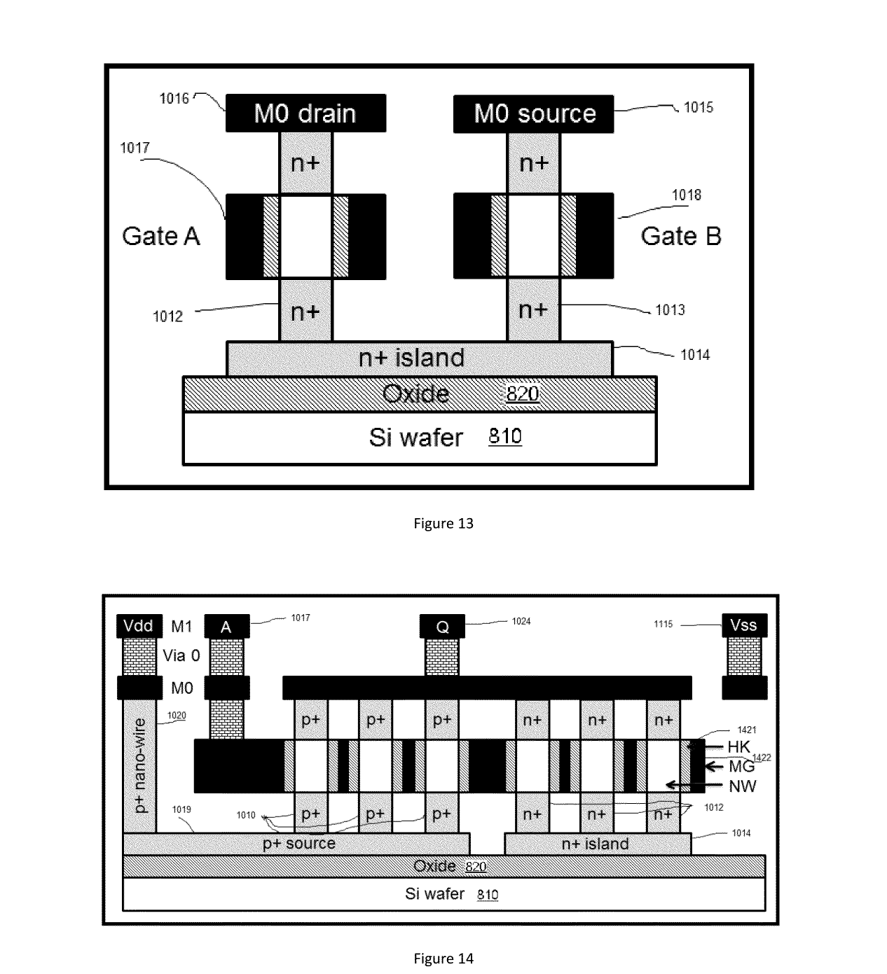

The output Q is connected to the metal-0 PMOS drain conductor 341 in the metal-0 layer, which in turn is connected to nanowires in the transistor 331 (FIG. 13). The input A is connected to the metal-1 connector 373 (FIG. 13), which in turn is connected to the first gate conductor 371.

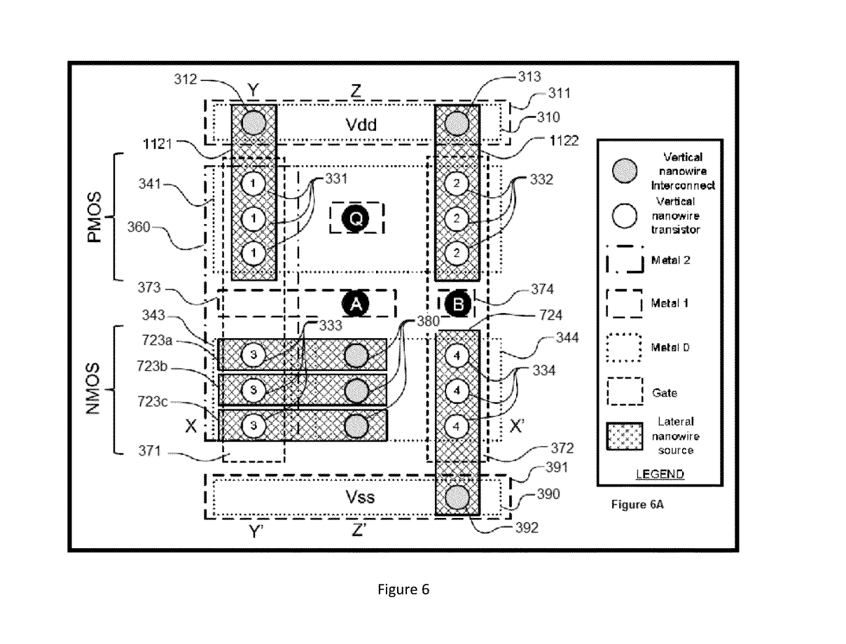

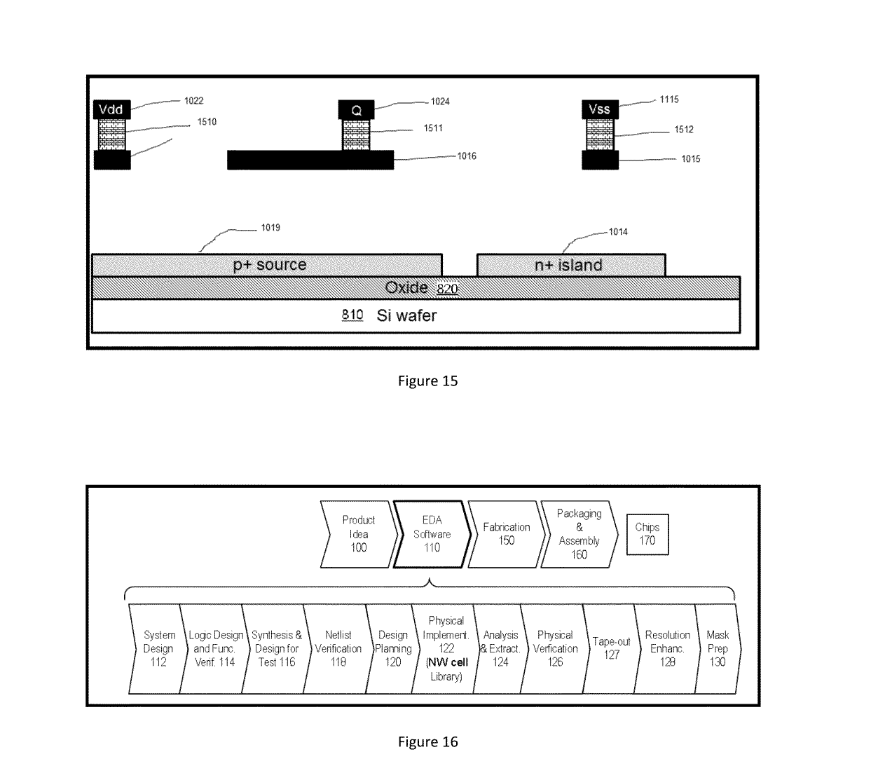

FIG. 6 is a simplified layout diagram showing a top view of a two-input NAND gate implemented with horizontal and vertical nanowires. FIG. 15A is a legend applicable to FIGS. 6 through 9. Like elements in FIGS. 6-9 are commonly referred to with like reference numerals in FIGS. 2-5.

Like elements in FIGS. 6-9 that are described in FIGS. 2-5 include the substrate (e.g. 810), sets of nanowires connected in parallel as transistors (e.g. 331-334), a set of nanowires connected in parallel as a nanowire interconnect (e.g. 380), metal layers (e.g. M0, M1, M2) and various conductors in the metal layers, source regions for the transistors, gate conductors crossing the sets of nanowires (e.g. 371, 372), inputs A and B, output Q, a VDD power conductor (e.g. 311), and a VSS power conductor (e.g. 391). Description about the like elements is not repeated for FIGS. 6-9.

A first set of nanowires can be configured as an interconnect disposed horizontally relative to the surface of the substrate, and connected in parallel between a first terminal and a second terminal. A second set of nanowires can be configured as an interconnect disposed horizontally relative to the surface of the substrate, and connected in parallel between a third terminal and a fourth terminal. The first set of nanowires includes a first number of nanowires, the second set of nanowires includes a second number of nanowires, and the second number can be different than the first number. A set of nanowires can have one or more nanowires.

As illustrated in the example of FIG. 6, horizontal nanowires are configured to connect to the drain ends or source ends of the nanowires in the set of nanowires of transistors in the two-input NAND gate. In particular, horizontal nanowire interconnects 721, 722 and 724 are configured to connect to the source ends of the nanowires in transistors 331, 332 and 334. Horizontal nanowire interconnects 723a, 723b and 723c are configured to connect to the source ends of the nanowires in the set of nanowires of the transistor 333.

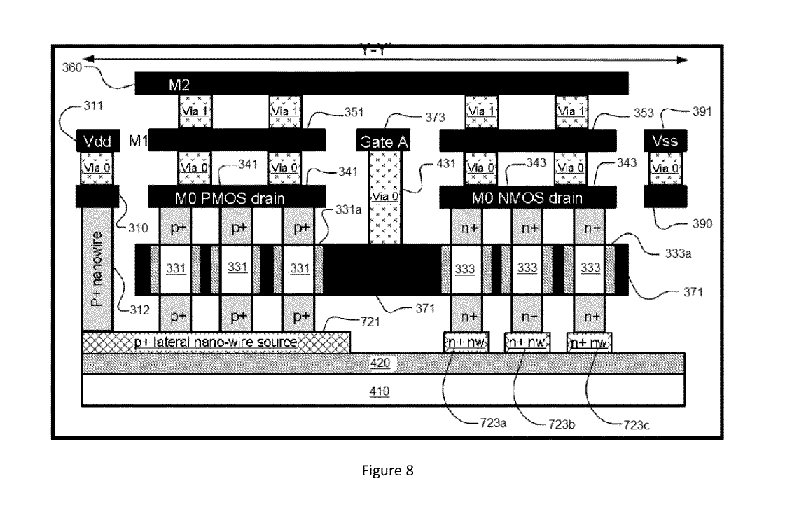

The metal-0 conductor 310 is connected to the VDD power conductor 311 in the metal-1 layer, connected to the horizontal nanowire interconnect 721 for the source of the PMOS transistor 331 via vertical nanowire interconnect 312 (beneath the nanowires of transistor 331, see FIG. 8), and connected to the horizontal nanowire interconnect 722 (beneath the nanowires of transistor 332) for the source of the PMOS transistor 332 via vertical nanowire interconnect 313. The metal-0 conductor 390 in the metal-0 layer is connected to a VSS power conductor 391 in the metal-1 layer, and connected to the nanowire interconnect 724 for the source of the NMOS transistor 334 via vertical nanowire interconnect 392.

A set of nanowires in a transistor are connected in parallel between two terminals. In particular, nanowires in transistor 331 are connected in parallel between terminals connected to the nanowire interconnect 721 and a metal-0 PMOS drain conductor 341 in the metal-0 layer, and nanowires in transistor 332 are connected in parallel between terminals connected to the nanowire interconnect 722 and the metal-0 PMOS drain conductor 341.

Nanowires in transistor 333 are connected in parallel between terminals connected to the nanowire interconnect including nanowires 723a, 723b and 723c, and a metal-0 NMOS drain conductor 343 in the metal-0 layer. Nanowires in transistor 334 are connected in parallel between terminals connected to the nanowire interconnect 724 and a metal-0 drain conductor 344.

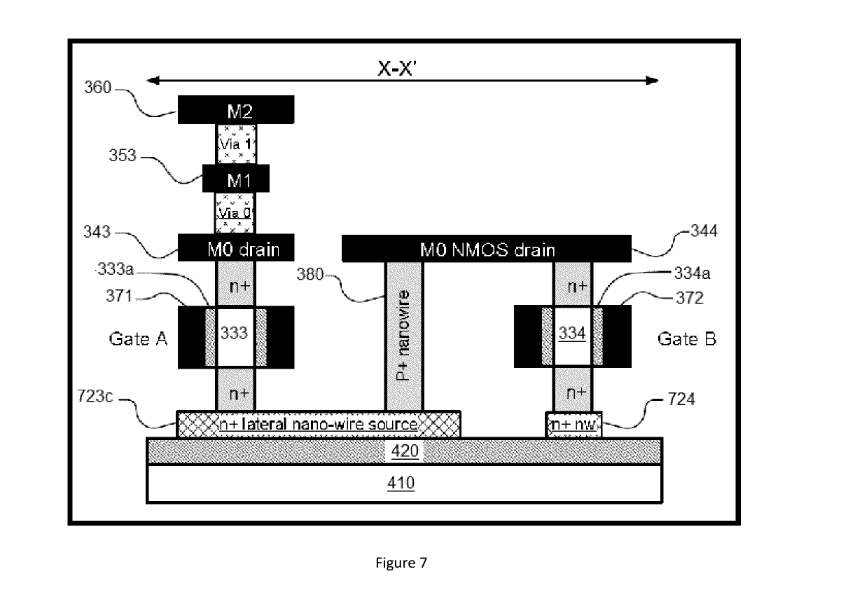

FIG. 7 is a layout diagram showing a cross-sectional view of the two-input NAND gate in FIG. 6 taken at X-X′. Nanowires in transistor 333 are connected in parallel between terminals connected to the nanowire interconnect 723c for the source of the transistor 333, and the metal-0 NMOS drain conductor 343 in the metal-0 layer. Nanowires in transistor 334 are connected in parallel between terminals connected to the nanowire interconnect 724 for the source of the transistor 334, and the metal-0 drain conductor 344. Vertical nanowires in the nanowire interconnect 380 are connected in parallel between the nanowire interconnect 723c for the source of the transistor 333, and the metal-0 NMOS drain conductor 344 of the transistor 334.

FIG. 8 is a layout diagram showing a cross-sectional view of the two-input NAND gate in FIG. 6 taken at Y-Y′. Nanowires in transistor 331 are connected in parallel between terminals connected to the nanowire interconnect 721 for the source of the transistor 331, and a metal-0 PMOS drain conductor 341 in the metal-0 layer. Nanowires in transistor 333 are connected in parallel between terminals connected to the nanowire interconnect including nanowires 723a, 723b and 723c for the source of transistor 333, and a metal-0 NMOS drain conductor 343 in the metal-0 layer.

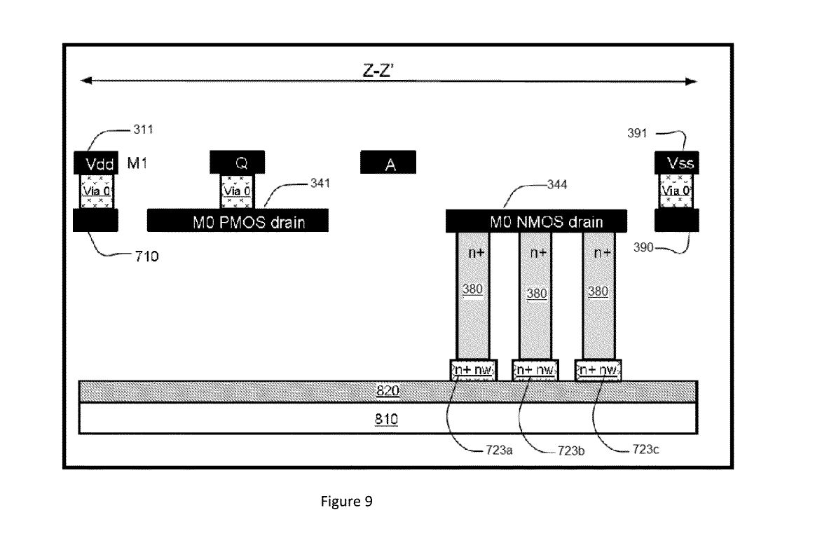

FIG. 9 is a layout diagram showing a cross-sectional view of the two-input NAND gate in FIG. 6 taken at Z-Z′. A set of nanowires configured as the nanowire interconnect 380 is disposed vertically relative to the surface of the substrate. The set of nanowires is connected in parallel between the nanowires 723a, 723b and 723c for the source of transistor 333, and the metal-0 NMOS drain conductor 344 of the transistor 334.

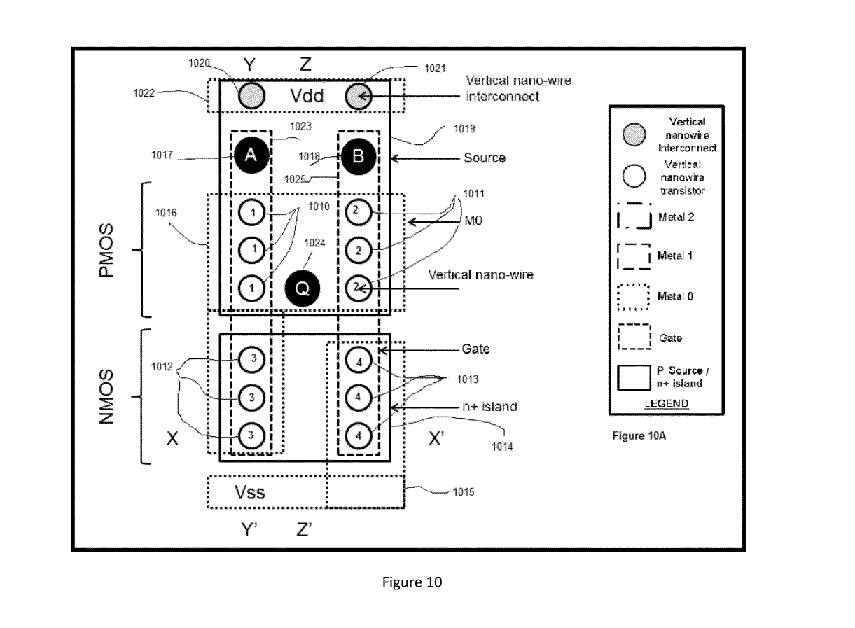

FIG. 10 is a simplified layout diagram showing a top view of a two-input NAND gate implemented with vertical nanowires devices and interconnects using vertical nanowires and an N+ island. FIG. 10A is a legend applicable to FIGS. 10 through 13.

In this implementation of the two-input NAND gate transistor 1010 including a first set of nanowires disposed vertically relative to the surface of the substrate can implement the PMOS transistor 231 in the two-input NAND gate 230 (FIG. 1B), and a transistor 1011 including a second set of nanowires disposed vertically relative to the surface of the substrate can implement the PMOS transistor 232 in the two-input NAND gate 230. Likewise, a transistor 1012 including a third set of nanowires disposed vertically relative to the surface of the substrate can implement the NMOS transistor 233 in the two-input NAND gate 230, and a transistor 1013 including a fourth set of nanowires disposed vertically relative to the surface of the substrate can implement the NMOS transistor 234 in the two-input NAND gate 230.

The source of the N transistors 1012 is connected to the drain of transistors 1013 through an N+ island 1014. The sources of the P transistors 1010 and 1011 are also connected through the common P+ SOI (Semiconductor-On-Insulator) island 1019.

Components in the layout of the two-input NAND gate include patterned conductor layers that include a first metal layer (metal-0 or M0) and gate conductors 1023 and 1025. Nanowires are beneath the metal-0 layer, and source or drain regions for the transistors are beneath the nanowires. The first gate conductor 1023 and the second gate conductor 1025 cross the sets of nanowires between the first metal layer and the source/drain regions of the nanowires. Although two patterned conductor layers are shown, more than two patterned conductor layers can be utilized.

Nanowires in a set of nanowires used as a channel structure in a transistor are connected in parallel between two terminals. In particular, nanowires in transistor 1010 are connected in parallel between terminals connected to the source region 1019 and a metal-0 PMOS drain conductor 1016 in the metal-0 layer, and nanowires in transistor 1011 are connected in parallel between terminals connected to the source region 1019 and the metal-0 PMOS drain conductor 1016.

Nanowires in transistor 1012 are connected in parallel between terminals connected to an N+SOI island 1014 and a metal-0 NMOS drain conductor 1016 in the metal-0 layer, and nanowires in transistor 1013 are connected in parallel between terminals connected to the N+ island 1014 and a metal-0 source conductor 1015. In this configuration the source of transistor 1012 and drain of transistor 1013 are therefore connected through the N+ island 1014.

A first gate conductor 1023 crosses the nanowires in the first set of nanowires in the transistor 1010, and crosses the nanowires in the third set of nanowires in the transistor 1012, between their respective two terminals. The first gate conductor 1023 is connected to input A 1017.

A metal-0 conductor 1022 in the metal-0 layer is connected to a VDD power conductor in the metal-1 layer, connected to the source region 1019 of the PMOS transistor 1010 via nanowire interconnect 1020, and connected to the source region 1019 of the PMOS transistor 1011 via nanowire interconnects 1021. A metal-0 conductor 1015 in the metal-0 layer is connected to a VSS power conductor in the metal-1 layer, and connected to the source of the NMOS transistor 1013.

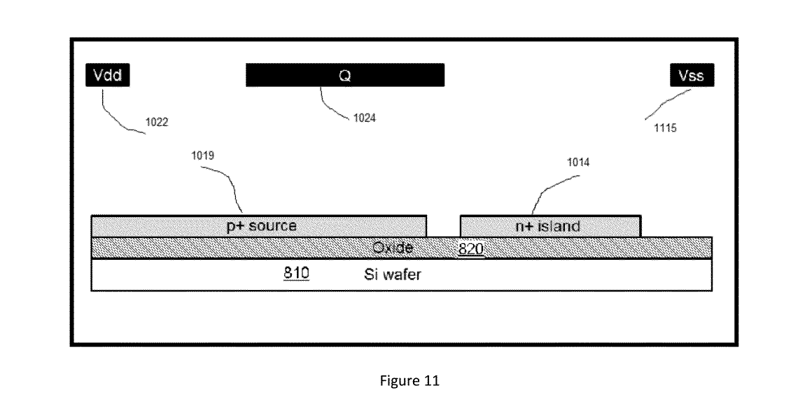

FIG. 11 is a layout diagram showing a cross-sectional view of the two-input NAND gate in FIG. 10 taken at Z-Z′. For the two sets of PMOS transistors 1010 and 1011 the p+ source area 1019 is the common source connection of the transistors. The p+ region is further connected to the top vdd connector 1022 by the vertical nanowire 1020 of FIG. 10. The n+ island 1014 allows the serial connection of the source of transistor 1012 to the drain of transistor 1013 eliminating the need of an added column of the vertical nanowire interconnect 380 shown in FIG. 2 of the classical 2-input NAND implementation.

Vss connector 1115 is connected to the source of transistor 1013 as described further in FIG. 13.

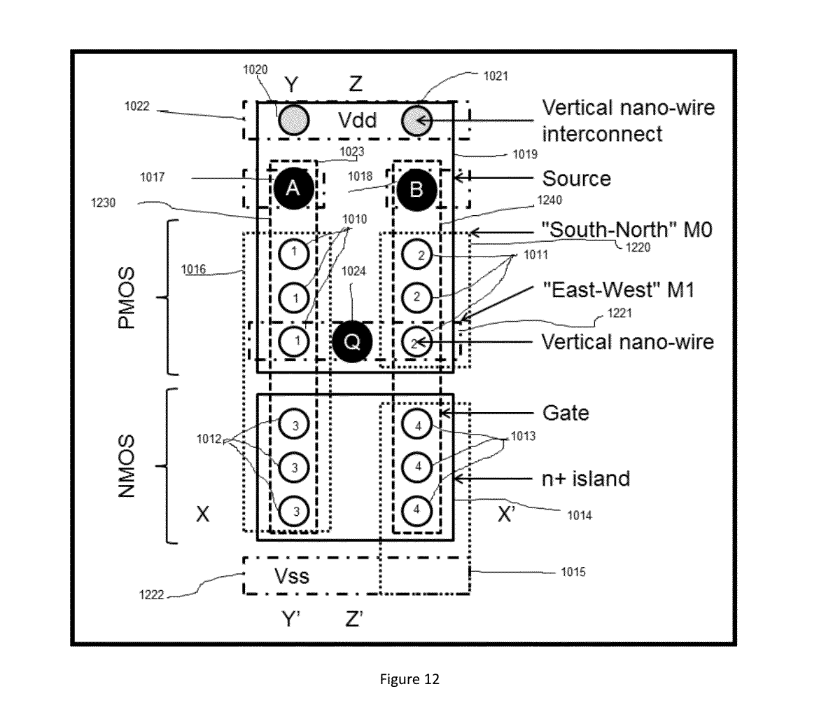

FIG. 12 is a simplified layout diagram that shows an alternative design of the 2-input NAND logic cell that uses one more metal layers (metal-1 or M1) than the layout shown on FIG. 10. The additional metal layer is necessary if a so-called “1D” interconnect approach is taken, with M0 oriented in south-north direction (i.e. from Vdd power bus towards Vss ground bus) and M1 oriented in east-west direction (i.e. perpendicular to M0 direction). The “1D” interconnect is easier to implement in terms of lithography and patterning and therefore it can be easier to manufacture. As illustrated in the example of FIG. 12, The metal-0 conductor 1022 is connected to the VDD power conductor in the metal-1 layer, connected to the vertical nanowire interconnect 1020 and 1021 for the sources of the PMOS transistors 1010 and 1011, respectively. The metal-0 conductor 1015 in the metal-0 layer is connected to a VSS power conductor 1222 in the metal-1 layer, to the source of the NMOS transistor 1013.

Gate 1230 is contacted through metal-0 and brought out at metal-1 connector 1017. Similarly gate 1240 is contacted to connector 1018, B at metal-1 through a metal-0 contact as illustrated further in FIG. 14 Metal-1 conductor 1221 with connector Q connects the two drains of P-transistors 1010 and 1011 and the drain of the N-transistor 1012 through metal-0 regions 1016 and 1220

FIG. 13 is a layout diagram showing a cross-sectional view of the two-input NAND gate N-devices of FIG. 12 with the n+ island interconnect taken at X-X′. The n+ island 1014 allows the serial connectivity of the drain of N-transistor 1013 of gate B, 1018 whose source is connected to VSS through the metal-0 (1015 of FIG. 12) to connect directly to the source of N-transistor 1012 with gate A, (1017 of FIG. 12), and drain connected to node Q (1024 of FIG. 12) without the need of a vertical nanowire interconnect as is the case of FIG. 2 and FIG. 3.

FIG. 14 is a layout diagram showing a cross-sectional view of the two-input NAND gate in FIG. 12 with n+ and p+ interconnect islands taken at Y-Y′. This cross section demonstrates the connectivity of the common gate A metal-1 connector 1017 through a via-0 and a metal-0 to the common gate of P-transistor 1010 and N-transistor 1012.

FIG. 15 is a layout diagram showing a cross-sectional view of the two-input NAND gate in FIG. 10 with M0 and M1 interconnect taken at Z-Z′. It shows the p+ source 1019 that connects the sources of the P-transistors 1010 and 1011 of FIG. 10 and the n+ island 1014 that connects the source of N-transistor 1012 to the drain of N-transistor 1013. FIG. 15 shows metal-1VDD, 1022 connected to the metal-0 of the p+ source vertical nanowire connector through via-0 1510. It similarly shows the metal-1 Q connector 1024 connected to the metal-0 common drains of P-transistors 1010 and 1011, and N-transistor 1012 through via-0 1511. Metal-1 connector VSS 1115 is connected to the source of N-transistor 1013 through metal-0 1015 and via-0 1512.

FIG. 16 shows a simplified representation of an illustrative integrated circuit design flow. As with all flowcharts herein, it will be appreciated that many of the steps of FIG. 16 can be combined, performed in parallel or performed in a different sequence without affecting the functions achieved. In some cases a rearrangement of steps will achieve the same results only if certain other changes are made as well, and in other cases a rearrangement of steps will achieve the same results only if certain conditions are satisfied.

At a high level, the process of FIG. 16 starts with the product idea (block 100) and is realized in an EDA (Electronic Design Automation) software design process (block 110). When the design is finalized, the fabrication process (block 150) and packaging and assembly processes (block 160) occur, ultimately resulting in finished integrated circuit chips (result 170).

The EDA software design process (block 110) is actually composed of a number of steps 112-130, shown in linear fashion for simplicity. In an actual integrated circuit design process, the particular design might have to go back through steps until certain tests are passed. Similarly, in any actual design process, these steps may occur in different orders and combinations. This description is therefore provided by way of context and general explanation rather than as a specific, or recommended, design flow for a particular integrated circuit.

A brief description of the component steps of the EDA software design process (block 110) will now be provided.

System design (block 112): The designers describe the functionality that they want to implement; they can perform what-if planning to refine functionality; check costs; etc. Hardware-software architecture selection can occur at this stage. Example EDA software products that have been available from Synopsys, Inc. that could be used at this step include Model Architect, Saber, System Studio, and DesignWare® products.

Logic design and functional verification (block 114): At this stage, high level description language (HDL) code, such as the VHDL or Verilog code, for modules in the system is written and the design is checked for functional accuracy. More specifically, the design is checked to ensure that it produces the correct outputs in response to particular input stimuli. Example EDA software products that have been available from Synopsys, Inc. that could be used at this step include VCS, VERA, DesignWare®, Magellan, Formality, ESP and LEDA products.

Synthesis and design for test (block 116): Here, the VHDL/Verilog is translated to a netlist. The netlist can be optimized for the target technology. Additionally, the design and implementation of tests to permit checking of the finished chip occur. Example EDA software products that have been available from Synopsys, Inc. that could be used at this step include Design Compiler®, Physical Compiler, Test Compiler, Power Complier, FPGA Compiler, TetraMAX, and DesignWare® products. Optimization of design for use of end-to-end finFET blocks as described below can occur in this stage.

Netlist verification (block 118): At this step, the netlist is checked for compliance with timing constraints and for correspondence with the VHDL/Verilog source code. Example EDA software products that have been available from Synopsys, Inc. that could be used at this step include Formality, PrimeTime, and VCS products.

Design planning (block 120): Here, an overall floor plan for the chip is constructed and analyzed for timing and top-level routing. Example EDA software products that have been available from Synopsys, Inc. that could be used at this step include Astro and IC Compiler products. Nanowire based functional cell selection, layout and optimization can occur at this stage.

Physical implementation (block 122): The placement (positioning of circuit elements) and routing (connection of the same) occurs at this step. Example EDA software products that have been available from Synopsys, Inc. that could be used at this step include AstroRail, Primetime, and Star RC/XT products. Nanowire based functional cell layout, mapping and interconnect arrangements can be implemented or optimized at this stage, using for example nanowire functional cells based on nanowire cell layouts and structures described herein.

Analysis and extraction (block 124): At this step, the circuit function is verified at a transistor level; this in turn permits what-if refinement. Example EDA software products that have been available from Synopsys, Inc. that could be used at this stage include Custom Designer, AstroRail, PrimeRail, Primetime, and Star RC/XT products.

Physical verification (block 126): At this stage various checking functions are performed to ensure correctness for: manufacturing, electrical issues, lithographic issues, and circuitry. Example EDA software products that have been available from Synopsys, Inc. that could be used at this stage include the Hercules product.

Tape-out (block 127): This stage provides the “tape-out” data for production of masks for lithographic use to produce finished chips. Example EDA software products that have been available from Synopsys, Inc. that could be used at this stage include the CATS® family of products.

Resolution enhancement (block 128): This stage involves geometric manipulations of the layout to improve manufacturability of the design. Example EDA software products that have been available from Synopsys, Inc. that could be used at this stage include Proteus/Progen, ProteusAF, and PSMGen products.

Mask preparation (block 130): This stage includes both mask data preparation and the writing of the masks themselves. Example EDA software products that have been available from Synopsys, Inc. that could be used at this stage include CATS® family of products.

Embodiments of the nanowire cell-based and block-based technology described herein can be used during one or more of the above-described stages, including for example one or more of stages 116 through 122 and 130. Also, nanowire cell and block technology provides flexibility that enables the implementation of engineering change orders ECOs, including modification of the functional cell sizes during design verification stages.

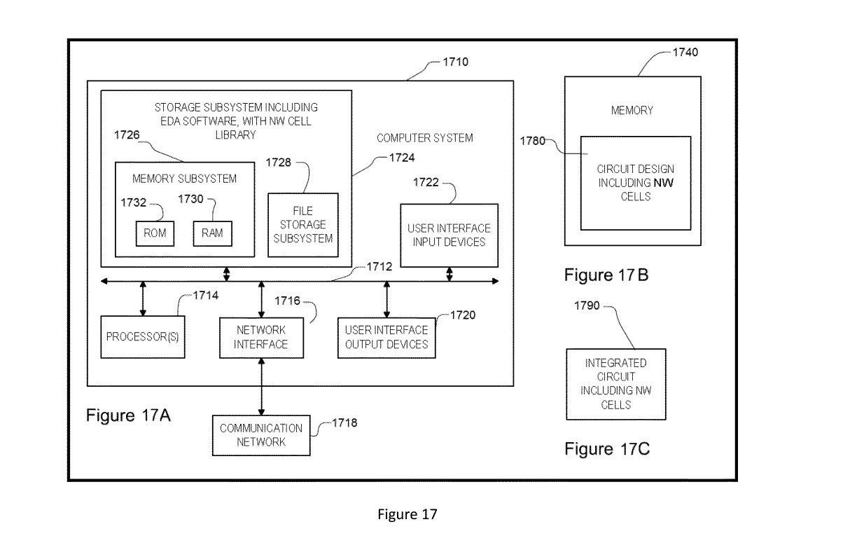

FIGS. 17A, 17B and 17C are simplified block diagrams of a computer system suitable for use with embodiments of the technology, as well as circuit design and circuit embodiments of the technology. Computer system 2010 typically includes at least one processor 2014 which communicates with a number of peripheral devices via bus subsystem 2012. These peripheral devices may include a storage subsystem 2024, comprising a memory subsystem 2026 and a file storage subsystem 2028, user interface input devices 2022, user interface output devices 2020, and a network interface subsystem 2016. The input and output devices allow user interaction with computer system 2010. Network interface subsystem 2016 provides an interface to outside networks, including an interface to communication network 2018, and is coupled via communication network 2018 to corresponding interface devices in other computer systems. Communication network 2018 may comprise many interconnected computer systems and communication links. These communication links may be wireline links, optical links, wireless links, or any other mechanisms for communication of information. While in one embodiment, communication network 2018 is the Internet, communication network 2018 may be any suitable computer network.

User interface input devices 2022 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include all possible types of devices and ways to input information into computer system 2010 or onto communication network 2018.

User interface output devices 2020 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 2010 to the user or to another machine or computer system.

Storage subsystem 2024 stores the basic programming and data constructs that provide the functionality of some or all of the EDA tools described herein, including the nanowire cell library in which at least on functional cell specifies a circuit implementation utilizing parallel sets of vertical and/or horizontal nanowires as described herein, and tools applied for development of functional cells for the library and for physical and logical design using the library. These software modules are generally executed by processor 2014.

Memory subsystem 2026 typically includes a number of memories including a main random access memory (RAM) 2030 for storage of instructions and data during program execution and a read only memory (ROM) 2032 in which fixed instructions are stored. File storage subsystem 2028 provides persistent storage for program and data files, and may include a hard disk drive, a floppy disk drive along with associated removable media, a CD-ROM drive, an optical drive, or removable media cartridges. The databases and modules implementing the functionality of certain embodiments may be stored by file storage subsystem 2028.

Bus subsystem 2012 provides a mechanism for letting the various components and subsystems of computer system 2010 communicate with each other as intended. Although bus subsystem 2012 is shown schematically as a single bus, alternative embodiments of the bus subsystem may use multiple busses.

Computer system 2010 itself can be of varying types including a personal computer, a portable computer, a workstation, a computer terminal, a network computer, a television, a mainframe, or any other data processing system or user device. Due to the ever-changing nature of computers and networks, the description of computer system 2010 depicted in FIG. 17A is intended only as a specific example for purposes of illustrating the preferred embodiments. Many other configurations of computer system 2010 are possible having more or less components than the computer system depicted in FIG. 17A.

FIG. 17B shows a memory 2040 such as a non-transitory, computer readable data storage medium associated with file storage subsystem 2028, and/or with network interface subsystem 2016 can include a data structure specifying a circuit design that includes functional cells from the nanowire cell library, or other nanowire cell-based or block-based functional cells as described in detail below. In other embodiments, the memory 2040 stores a functional cell library that includes functional cells implemented using a flexible nanowire cell structure. The memory 2040 can be a hard disk, a floppy disk, a CD-ROM, an optical medium, removable media cartridge, or other medium that stores computer readable data in a volatile or non-volatile form. The memory 2040 is shown storing a circuit design 2080, including for example a description of geometric features of a circuit implementing a functional cell or macrocell, that includes one or more nanowire block functional cells created with the nanowire technology described herein.

FIG. 17C is a block representing an integrated circuit 2090 created with the described technology that includes one or more nanowire functional cells, and/or functional cells selected from a nanowire cell library.

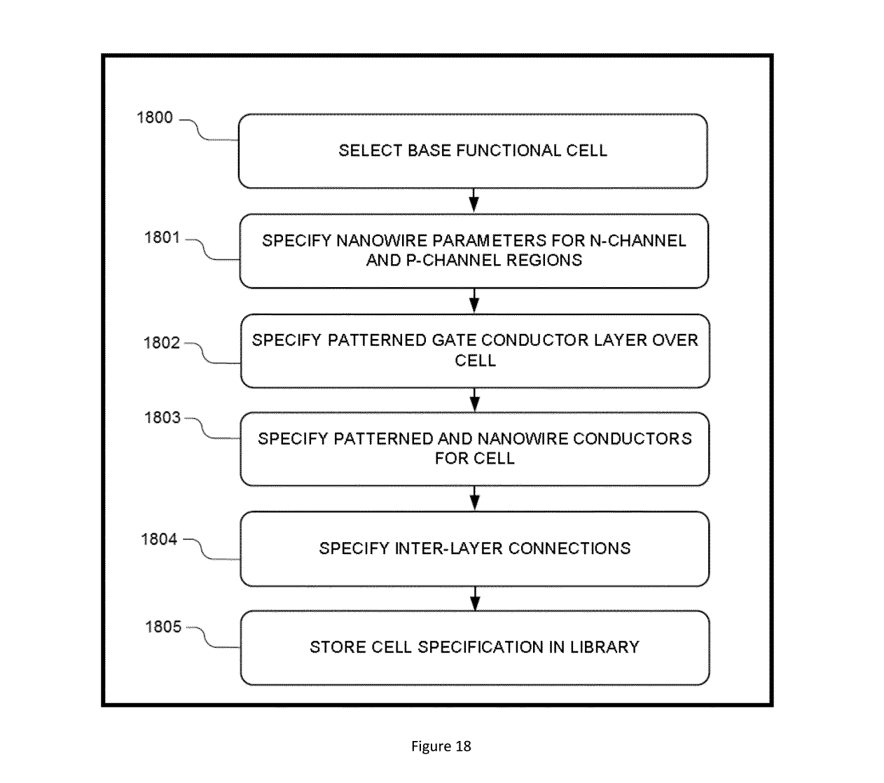

FIG. 18 is a simplified flow diagram of a process for designing a nanowire cell for a cell library. The method may be performed, for example, by an interactive software tool that is used by a cell designer to create a library of cells. The order of the steps can be modified as suits a particular design. According to the simplified flow diagram, a base functional cell to be included in a cell library is selected (2100). Such a base cell can be an inverter as described above, a flip-flop, logic gates, logic blocks or other cell structures. A base cell may consist of a configuration like that of FIGS. 3A-3B or 4A-4B in which the number of rows of p-channel nanowires, the number of layers of p-channel nanowires, the number of rows of n-channel nanowires, and the number of layers of n-channel nanowires are selectable parameters, within a set of parameters available according to a target manufacturing process or target manufacturing processes. In other examples, the user may specify a cell characteristic, such as conductance of the transistors in the on state, or drive ability of the cell. The design tool could use the user specified characteristic to determine cell features including the number of rows and layers of p-channel nanowires, and the number of rows and layers of n-channel nanowires. User input may specify or provide input used to determine other features, including gate dimensions for example, and features relating to the shape and location of objects in the cell (e.g., cell boundary, location and width of power conductors, gates, active areas) and so on (2101). Then, the patterned gate conductor layer is specified, to form gates in rows overlying the sets of nanowires that will be used for transistors in the cell (2102). Then, the patterned conductor layers are specified, to establish appropriate interconnections, preferably including a layer having conductors arranged in columns, and a layer having conductors arranged in rows (2103). The plurality of patterned conductor layers includes power conductors. Then the interlayer connections are specified, to locate connections among the nanowires, the gate conductors, nanowire interconnects and the conductors in the one or more patterned conductor layers (2104). The specifications produced in this method comprise layout files implemented in a GDS II format database file representing the specified geometric shapes of the elements and nanowire shapes, or other computer readable format. The specified cells are then stored in a cell library for use in integrated circuit design (2105). The process may be repeated to generate a cell library that includes a large number of cells implementing different functions and performance specifications. In addition, a cell library can be implemented in which a plurality of entries specify implementations of a common circuit configuration, such as a NAND gate circuit as shown in FIG. 1B. Each of the entries specifying a common NAND gate circuit using nanowires can differ in the number of nanowires used for a particular transistor or used for a particular interconnect. For example, the particular transistor 633 in the circuit configuration of FIG. 1B can have a set of nine nanowires in one entry in the cell library, and have a set of 10 nanowires in another entry in the cell library.

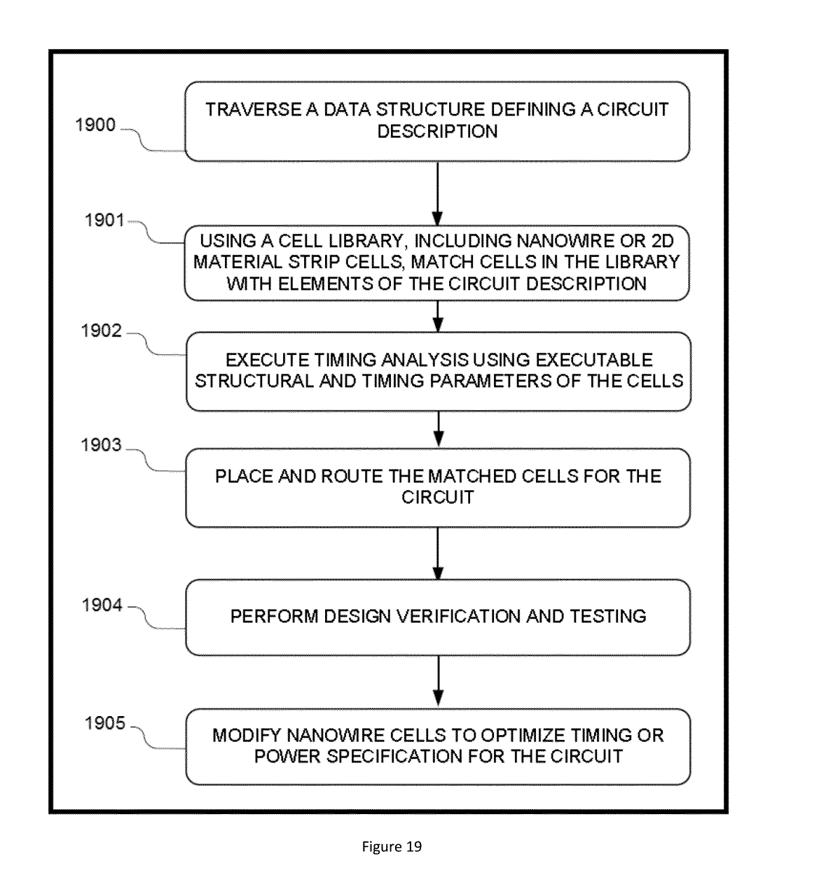

FIG. 19 is a flowchart for a representative design automation process which can be implemented as logic executed by a system like that represented by FIGS. 17A, 17B and 17C, including a nanowire cell library having cells implemented using at least one nanowire cell as described herein. According to a first step of the process, a data structure that defines a circuit description, such as a netlist, is traversed in data processing system (2200). A cell library stored in a database or other computer readable medium coupled with the data processing system, that includes nanowire cells as described herein, is accessed by the data processing system, and utilized to match cells in the library with the elements of the circuit description (2201). The matched cells are then placed and routed for an integrated circuit layout (2202). Next, design verification and testing is executed (2203). Finally, nanowire cells can be modified to optimize timing or power specifications for the circuit (2204). The modifications of the nanowire cells can comprise mask changes that result in changes to the conductors in the patterned conductor layers, and in the pattern of interlayer connectors, to change the number of nanowires utilized in a particular transistor. These changes can be accomplished in some instances without changing the area on the integrated circuit occupied by the cell.

A nanowire cell architecture described above can be utilized to create a flexible library that comprises a plurality of nanowire cells meeting different functional specifications.

In general, the creation of a nanowire cell flexible library is enabled using the nanowire architectures described herein. In such library, the standard cells can consist of “soft macros” that could be populated with some flexibility as to the exact location, or the exact number of nanowires used in implementation, of their underlying elements. Unlike planar CMOS structures, where the granularity for modifications or adjustments of the cells is the whole transistor, in nanowire cell architectures as described herein, the granularity can be a single nanowire.

A library can be comprised of a plurality of nanowire cell functional cells which exploit subsets of the available nanowire options in the cells, leaving room for optimization procedures that do not alter the area of the layout.

The following table provides a representation of an organization a functional cell library having a plurality of entries. Some of the information which can be included in the entries as illustrated in the table.

| | |
|---|---|
| NAND-1 | Layout file including transistors T1, T2, . . . |
| | and interconnects X1, X2 . . . |
| | n-channel T1 having parallel nanowire |
| | channel - 3 stacks of 3 layers each, |
| | p-channel T2 having parallel nanowire |
| | channel- 4 stacks of 3 layers each, |
| | n-channel T3 having 6 parallel nanowire |
| | channel - 2 stacks of 3 layers each, |
| | . . . |
| | Interconnect X1 having 16 parallel |
| | nanowires |
| | Interconnect X2 having 8 parallel |
| | nanowires |
| | . . . |
| NAND-2 | Layout file including transistors T1, T2, . . . |
| | and interconnects X1, X2 . . . |
| | n-channel T1 having parallel nanowire |
| | channel - 2 stacks of 5 layers each,, |
| | p-channel T2 having parallel nanowire |
| | channel- 2 stacks of 6 layers each, |
| | n-channel T3 having parallel nanowire |
| | channel- 3 stacks of 2 layers each and 1 |
| | stack of 2X width and layers |
| | . . . |
| | Interconnect X1 having 16 parallel |
| | nanowires |
| | Interconnect X2 having 8 parallel |
| | nanowires |
| | . . . |
| . . . | |
| NOR-1 | Layout file including transistors T1, T2, . . . |
| | and interconnects X1, X2 . . . |
| | n-channel T1 having 10 parallel nanowire |
| | channel, |
| | p-channel T2 having 12 parallel nanowire |
| | channel |
| | n-channel T3 having 8 parallel nanowire |
| | channel |
| | . . . |
| | Interconnect X1 having 16 parallel |
| | nanowires |
| | Interconnect X2 having 8 parallel |
| | nanowires |
| NOR-2 | Layout file including transistors T1, T2, . . . |
| | and interconnects X1, X2 . . . |
| | n-channel T1 having 9 parallel nanowire |
| | channel, |
| | p-channel T2 having 12 parallel nanowire |
| | channel |
| | n-channel T3 having 6 parallel nanowire |
| | channel |
| | . . . |
| | Interconnect X1 having 16 parallel |
| | nanowires |
| | Interconnect X2 having 8 parallel |
| | nanowires |
| . . . | |
| BUFFER 1 | Layout file including transistors T1, T2, . . . |
| | and interconnects X1, X2 . . . |
| | n-channel T1 having 9 parallel nanowire |
| | channel, |
| | p-channel T2 having 12 parallel nanowire |
| | channel |
| | . . . |
| | Interconnect X1 having 16 parallel |
| | nanowires |
| | Interconnect X2 having 8 parallel |
| | nanowires |
| BUFFER 2 | Layout file including transistors T1, T2, . . . |
| | and interconnects X1, X2 . . . |
| | n-channel T1 having 3 parallel nanowire |
| | channel, |
| | p-channel T2 having 5 parallel nanowire |
| | channel |
| | . . . |
| | Interconnect X1 having 8 parallel |
| | nanowires |
| | Interconnect X2 having 8 parallel |
| | nanowires |
| . . . | |
| SRAM ARRAY | Unit cell file including transistors T1, T2, . . . |
| MACROCELL 1 | and interconnects X1, X2 . . . |
| | n-channel T1 having 9 parallel horizontal |
| | nanowire channel, |
| | p-channel T2 having 12 parallel horizontal |
| | nanowire channel |
| | n-channel T3 having 6 parallel horizontal |
| | nanowire channel |
| | . . . |
| | Interconnect X1 having . . . |
| | Interconnect X2 having . . . |
| | Bit lines . . . |
| | Word lines . . . |
| SRAM ARRAY | Unit cell file including transistors T1, T2, . . . |
| MACROCELL 2 | and interconnects X1, X2 . . . |
| | n-channel T1 having 9 parallel horizontal |
| | nanowire channel, |
| | p-channel T2 having 12 parallel horizontal |
| | nanowire channel |
| | n-channel T3 having 6 parallel horizontal |
| | nanowire channel |
| | . . . |
| | Interconnect X1 having . . . |
| | Interconnect X2 having . . . |
| | Bit lines comprising horizontal sets of |
| | nanowires interconnectiong unit cells |
| | Word lines . . . |
| . . . | |

In the functional cell library represented by the above table there is a set of entries for NAND cells, including NAND-1 and NAND-1. The entries in the set of entries specifying NAND cells can specify a functional circuit having in common a circuit configuration for a NAND cell. Entries in the set specifying a functional circuit having a common circuit configuration specify implementation the same number of transistors interconnected in the same manner. The entries can differ as described herein, in the number of parallel nanowires utilized in particular transistors. Thus, for the entry NAND-1, the specified n-channel transistor T1 has a channel comprising a set of nine parallel nanowires, arranged in three stacks of three layers each. The specified p-channel transistor T2 as a channel comprising a set of 12 parallel nanowires, arranged in four stacks of three layers each. The specified n-channel transistor T3 as a channel comprising six parallel nanowires, arranged in two stacks of three layers each. For the entry NAND-2, the specified n-channel transistor T1 has a channel comprising a set of 10 parallel nanowires, arranged in two stacks of five layers each. The specified p-channel transistor T2 as a channel comprising a set of 12 parallel nanowires, arranged in two stacks of six layers each. The specified n-channel transistor T3 as a channel comprising eight parallel nanowires, arranged in four stacks of two layers each and in which the nanowire in one of the four stacks consists of nanowires have a width greater than two times the height (“2× width”). The entries in a set of entries for a particular functional cell can differ only in the number of parallel nanowires in the channel of a particular transistor. Alternatively, entries in the set of entries for particular functional cell can differ only in the number of parallel nanowires used in a particular interconnect within the cell.

The cell library represented by the table also includes a set of entries specifying NOR cells and a set of entries specifying buffers. The entries in the set of the NOR cells have in common the same circuit configuration, where the differences arise in the number of parallel nanowires used in the various components within the cell. Likewise, the entries in the set of buffer cells have in common the same circuit configuration, and differences that arise in the number of parallel nanowires used in the various components within the cell.

The cell library also includes entries that specify SRAM macro cells, where a macrocell consists of a plurality of unit cells and connections between the unit cells. For SRAM macro cells, the unit cell can be a six transistor memory element. The number of nanowires utilized in the various transistors within the unit cell can be tuned for the purposes of optimizing performance of the unit cell. The SRAM macro cells can differ in the form of the bit lines utilized for connections among the unit cells. Thus, SRAM ARRAY MACROCELL 1 can specify a patterned metal layer interconnected with horizontal nanowire transistors, to act as bit lines. SRAM ARRAY MACROCELL 2 can specify bit lines that comprise a horizontal sets of nanowires that interconnect the unit cells, which in turn comprise transistors having channels consisting of parallel vertical nanowires.

The entries in the cell library can be selected according to performance specifications provided by a user to satisfy the elements in a circuit design, such as a netlist.

Specifications provided by the entries can define the geometry of the components of the cells and macrocells. Also, the entries can define or be utilized to define lithographic mask layers for each cell or macrocell and for a circuit incorporating the cells or macrocells. The specifications can then be utilized to produce a set of masks for a manufacturing process implementing the cells or macrocells selected for the circuit design, or implementing a circuit incorporating the cells or macrocells.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims. What is claimed is:

1. A computer system adapted to process a computer implemented representation of a circuit design, comprising:
a processor and a memory coupled to the processor, the memory storing processor readable parameters specifying structural features of a physical implementation of a circuit, the circuit including:
a plurality of nanowire transistors; and
a nanowire interconnect,
wherein at least two nanowire transistors in the plurality are electrically in series via at least the nanowire interconnect.

2. The computer system of claim 1, wherein said at least two transistors are oriented vertically relative to a substrate, and further comprising:
a conductor electrically connecting a source terminal of a first transistor of said at least two transistors and a drain terminal of a second transistor of said at least two transistors.

3. The computer system of claim 2, wherein said first transistor and said second transistor are a same conductivity type.

4. The computer system of claim 1, wherein the nanowire interconnect has an opposite conductivity type in contrast with said first vertical nanowire transistor and said second vertical nanowire transistor.

5. The computer system of claim 1, wherein said at least two nanowire transistors include a first vertical nanowire transistor and a second vertical nanowire transistor both being n-type transistors, and said nanowire interconnect is a first vertical nanowire electrically connecting a first drain of the first vertical nanowire transistor with a first source of the second vertical nanowire transistor.

6. A computer program product, comprising:
a memory device having stored thereon a computer readable specification of a cell, the specification of the cell including computer readable parameters specifying structural features of a physical implementation of a circuit, the circuit including:
a plurality of nanowire transistors; and
a nanowire interconnect,
wherein at least two nanowire transistors in the plurality are electrically in series via at least the nanowire interconnect.

7. The computer program product of claim 6, wherein said at least two transistors are oriented vertically relative to a substrate, and further comprising:
a conductor electrically connecting a source terminal of a first transistor of said at least two nanowire transistors and a drain terminal of a second nanowire transistor of said at least two nanowire transistors.

8. The computer program product of claim 7, wherein said first transistor and said second transistor are a same conductivity type.

9. The computer program product of claim 6, wherein the nanowire interconnect has an opposite conductivity type in contrast with said first vertical nanowire transistor and said second vertical nanowire transistor.

10. The computer program product of claim 6, wherein said at least two nanowire transistors include a first vertical nanowire transistor and a second vertical nanowire transistor both being n-type transistors, and said nanowire interconnect is a first vertical nanowire electrically connecting a first drain of the first vertical nanowire transistor with a first source of the second vertical nanowire transistor.

11. A computer program product, comprising:
a memory device having stored thereon a machine readable specification of a cell, the specification of the cell including computer readable parameters specifying structural features of a physical implementation of a circuit, the circuit including:
an array of circuit cells, the circuit cells including a plurality of nanowire transistors and a vertical nanowire interconnect,
wherein the plurality of nanowire transistors includes:
a first vertical nanowire transistor including: a first gate at a first intermediate height in between a first source at a first source height and a first drain at a first drain height;
a second vertical nanowire transistor including: a second gate at a second intermediate height in between a second source at a second source height and a second drain at a second drain height;
wherein the vertical nanowire interconnect traverses the first intermediate height of the first vertical nanowire transistor, and traverses the second intermediate height of the second vertical nanowire transistor, to electrically couple in series the first vertical nanowire transistor and the second vertical nanowire transistor.

12. The computer program product of claim 11, wherein said first vertical nanowire transistor and said second vertical nanowire transistor are a same conductivity type.

13. The computer program product of claim 11, wherein said first vertical nanowire transistor and said second vertical nanowire transistor are a same conductivity type, and the vertical nanowire interconnect has an opposite conductivity type in contrast with said first vertical nanowire transistor and said second vertical nanowire transistor.

14. The computer program product of claim 11, wherein said first vertical nanowire transistor and said second vertical nanowire transistor are n-type transistors, and said first vertical nanowire electrically connects the first drain of the first vertical nanowire transistor with the first source of the second vertical nanowire transistor.

15. The computer program product of claim 11, wherein said first vertical nanowire transistor and said second vertical nanowire transistor are a same conductivity type, and
wherein the circuit further comprises:
a third vertical nanowire transistor and a fourth vertical nanowire transistor having an opposite conductivity type in contrast with said first vertical nanowire transistor and said second vertical nanowire transistor;
a first conductor electrically connecting the first gate of the first vertical nanowire transistor with a third gate of the third vertical nanowire transistor; and
a second conductor electrically connecting the second gate of the second vertical nanowire transistor with a fourth gate of the fourth vertical nanowire transistor,
wherein the first conductor and the second conductor are different electrical inputs of a NAND gate.

16. A computer system adapted to process a computer implemented representation of a circuit design, comprising:
a processor and a memory coupled to the processor, the memory storing including processor readable parameters specifying structural features of a physical implementation of a circuit; the circuit including:
an array of circuit cells, the circuit cells including a plurality of nanowire transistors and a vertical nanowire interconnect,
wherein the plurality of nanowire transistors includes:
a first vertical nanowire transistor including: a first gate at a first intermediate height in between a first source at a first source height and a first drain at a first drain height; and
a second vertical nanowire transistor including: a second gate at a second intermediate height in between a second source at a second source height and a second drain at a second drain height,
wherein the vertical nanowire interconnect traverses the first intermediate height of the first vertical nanowire transistor, and traverses the second intermediate height of the second vertical nanowire transistor, to electrically couple in series the first vertical nanowire transistor and the second vertical nanowire transistor.

17. The computer system of claim 16, wherein said first vertical nanowire transistor and said second vertical nanowire transistor are a same conductivity type.

18. The computer system of claim 16, wherein said first vertical nanowire transistor and said second vertical nanowire transistor are a same conductivity type, and the vertical nanowire interconnect has an opposite conductivity type in contrast with said first vertical nanowire transistor and said second vertical nanowire transistor.

19. The computer system of claim 16, wherein said first vertical nanowire transistor and said second vertical nanowire transistor are n-type transistors, and said first vertical nanowire electrically connects the first drain of the first vertical nanowire transistor with the first source of the second vertical nanowire transistor.

20. The computer system of claim 16, wherein said first vertical nanowire transistor and said second vertical nanowire transistor are a same conductivity type,
wherein the circuit further comprises:
a third vertical nanowire transistor and a fourth vertical nanowire transistor having an opposite conductivity type in contrast with said first vertical nanowire transistor and said second vertical nanowire transistor;
a first conductor electrically connecting the first gate of the first vertical nanowire transistor with a third gate of the third vertical nanowire transistor; and
a second conductor electrically connecting the second gate of the second vertical nanowire transistor with a fourth gate of the fourth vertical nanowire transistor,
wherein the first conductor and the second conductor are different electrical inputs of a NAND gate.
